(19) United States
(12) Patent Application Publication
(10) Pub. No.: US 2025/0261791 A1
(43) Pub. Date: Aug. 21, 2025

(54) ROTISSERIE ASSEMBLY FOR AN OVEN APPLIANCE

(71) Applicant: Haier US Appliance Solutions, Inc., Wilmington, DE (US)

(72) Inventors: Rebekah Leigh Tyler, Louisville, KY (US); David William Billman, Louisville, KY (US); Mario Battaglia, Fort Lauderdale, FL (US)

(21) Appl. No.: 18/444,377

(22) Filed: Feb. 16, 2024

(51) Int. Cl. A47J 37/04; F24C 15/16

(52) U.S. Cl. CPC A47J 37/041; F24C 15/164

(57) ABSTRACT

An oven appliance includes a cooking chamber positioned within a cabinet, a door rotatably mounted to the cabinet for providing selective access to the cooking chamber, a rotisserie assembly including a spit rod rotatably mounted within the cooking chamber and defining an axial direction, and a radial direction and a rotisserie fork assembly mounted on the spit rod and being slidable along the axial direction, the rotisserie fork assembly comprising a plurality of tines that are adjustable along the radial direction.

### FIELD OF THE INVENTION

The present subject matter relates generally to oven appliances, and more particularly, to oven appliances including rotisserie assemblies.

### BACKGROUND OF THE INVENTION

Conventional residential and commercial oven appliances generally include a cabinet that includes a cooking chamber for receipt of food items for cooking. Multiple heating elements are positioned within the cooking chamber to provide heat to food items located therein. The heating elements can include, for example, radiant heating elements, such as a bake heating assembly positioned at a bottom of the cooking chamber and/or a separate broiler heating assembly positioned at a top of the cooking chamber.

One traditional method of cooking is rotisserie cooking, also known as spit-roasting. This type of cooking includes skewering a food item, typically meat, on a long rod and securing the meat with a rotisserie fork to prevent the meat from rotating relative to the rod. The spit rod is then slowly rotated over a fire or hot coals to roast the meat slowly and evenly. For example, this type of cooking is commonly used to roast large cuts of meat, such as turkeys, hams, sirloins, whole chickens, etc. Notably, conventional rotisserie forks are not capable of handling the large variation in the size and weight of rotisserie items. For example, one set of forks may be suitable for holding a pineapple but may be too small for holding a turkey. Moreover, assembling and storing separate sizes of rotisserie forks may be time-consuming and burdensome.

Accordingly, an oven appliance that includes features that facilitate rotisserie cooking on a wide variety of food items would be useful. More particularly, a rotisserie assembly for an oven appliance that includes forks that are versatile and capable of use with multiple food items would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, an oven appliance defining a vertical, a lateral, and a transverse direction is provided. The oven appliance includes a cooking chamber positioned within a cabinet, a door rotatably mounted to the cabinet for providing selective access to the cooking chamber, and a rotisserie assembly. The rotisserie assembly includes a spit rod rotatably mounted within the cooking chamber and defining an axial direction and a radial direction and a rotisserie fork assembly mounted on the spit rod and being slidable along the axial direction, the rotisserie fork assembly comprising a plurality of tines that are adjustable along the radial direction.

In another exemplary embodiment, a rotisserie assembly for an oven appliance is provided. The oven appliance includes a cooking chamber positioned within a cabinet and the rotisserie assembly includes a spit rod rotatably mounted within the cooking chamber and defining an axial direction and a radial direction and a rotisserie fork assembly mounted on the spit rod and being slidable along the axial direction, the rotisserie fork assembly comprising a plurality of tines that are adjustable along the radial direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front view of an oven appliance according to an example embodiment of the present subject matter.

FIG. 2 is a perspective, cross-sectional view of the example oven appliance of FIG. 1, taken along Line 2-2 in FIG. 1.

FIG. 3 is a side, cross-sectional view of the example oven appliance of FIG. 1, taken along Line 2-2 in FIG. 1.

FIG. 4 is a perspective view of the example oven appliance of FIG. 1 with the door removed to reveal a rotisserie assembly according to an example embodiment of the present subject matter.

FIG. 5 is a perspective view of the example rotisserie assembly of FIG. 4 according to an example embodiment of the present subject matter.

FIG. 6 is an exploded view of the example rotisserie assembly of FIG. 4 according to an example embodiment of the present subject matter.

FIG. 7 is a perspective view of a spit support of the example rotisserie assembly of FIG. 4 according to an example embodiment of the present subject matter.

FIG. 8 is a front view of a rotisserie fork assembly of the example rotisserie assembly of FIG. 4 according to an example embodiment of the present subject matter.

FIG. 9 is an exploded view of the example rotisserie fork assembly of FIG. 8 according to an example embodiment of the present subject matter.

FIG. 10 is a perspective view of an outer disk of the example rotisserie fork assembly of FIG. 8 according to an example embodiment of the present subject matter.

FIG. 11 is a perspective view of an inner disk of the example rotisserie fork assembly of FIG. 8 according to an example embodiment of the present subject matter.

FIG. 12 is a perspective view of a tine of the example rotisserie fork assembly of FIG. 8 according to an example embodiment of the present subject matter.

FIG. 13 provides a method of operating an oven appliance with a rotisserie assembly according to an exemplary embodiment of the present subject matter.

FIG. 14 provides a flow chart illustrating the implementation of a rotisserie cooking process of an oven appliance with a rotisserie assembly according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

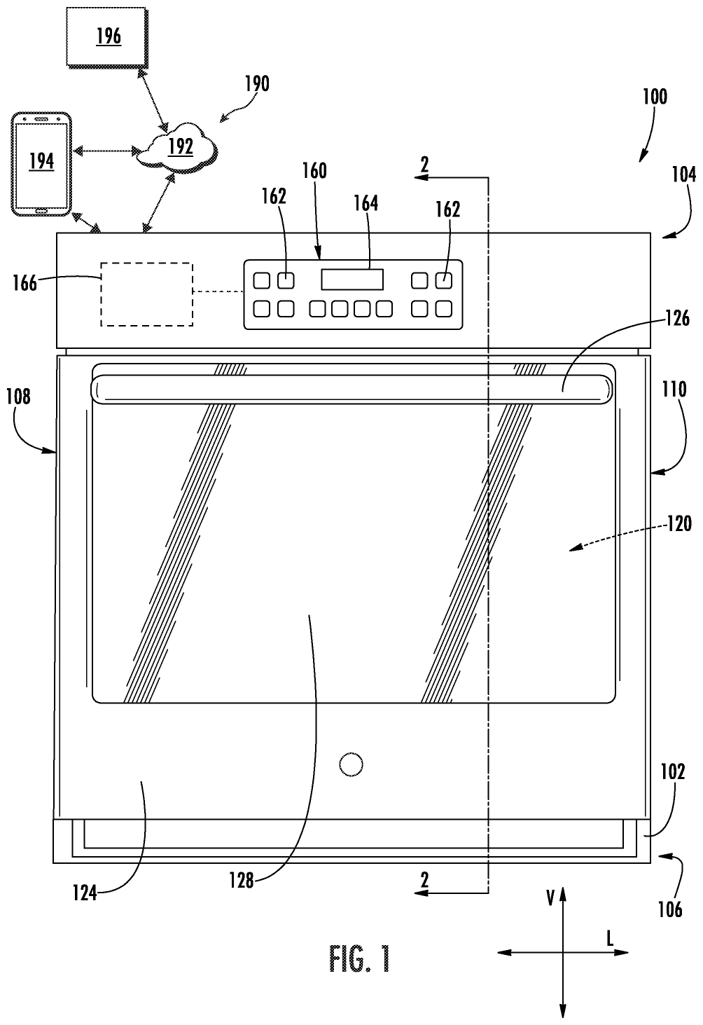

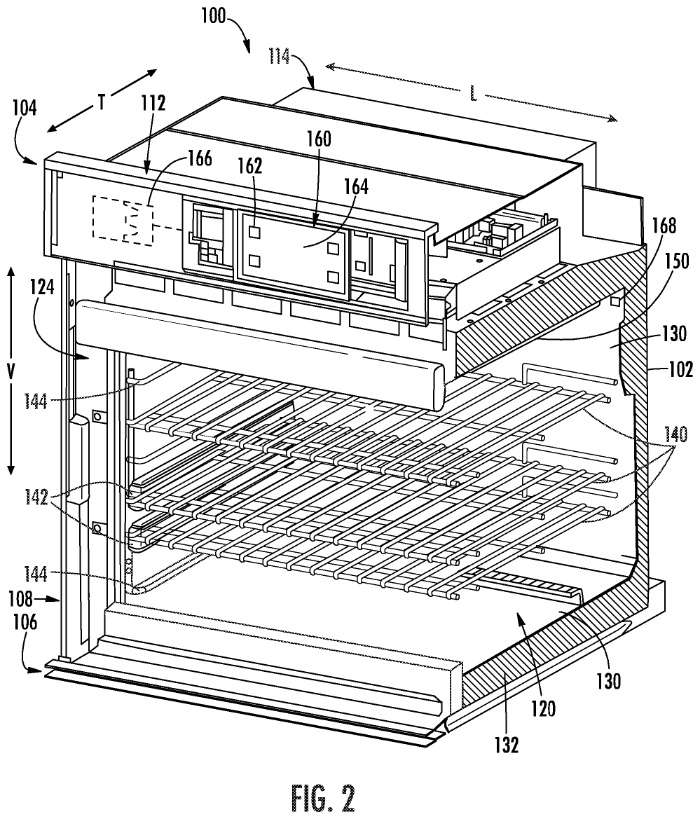

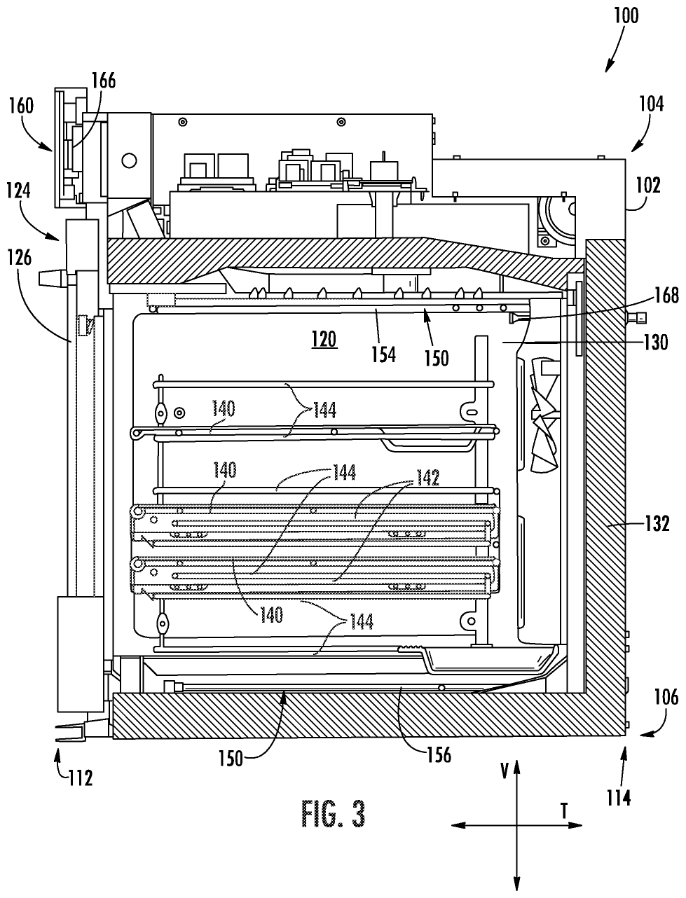

FIG. 1 provides a front view of an oven appliance 100 as may be employed with the present subject matter. In addition, FIGS. 2 and 3 provide perspective and side cross-sectional views, respectively, of oven appliance 100. As shown, oven appliance 100 generally defines a vertical direction V, a lateral direction L, and a transverse direction T, each of which is mutually perpendicular, such that an orthogonal coordinate system is generally defined. As illustrated, oven appliance 100 includes an insulated cabinet 102. Cabinet 102 of oven appliance 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

Within cabinet 102 is a single cooking chamber 120 which is configured for the receipt of one or more food items to be cooked. However, it should be appreciated that oven appliance 100 is provided by way of example only, and aspects of the present subject matter may be used in any suitable cooking appliance, such as a gas or electric double oven range appliance. For example, although oven appliance 100 is illustrated as a wall oven installed within a bank of cabinets, it should be appreciated that aspects of the present subject matter may be used in free-standing oven appliances, double ovens, etc. Moreover, aspects of the present subject matter may be used in any other consumer or commercial appliance where it is desirable to use a rotisserie within another suitable appliance. Thus, the example embodiment shown in FIGS. 1 through 3 is not intended to limit the present subject matter to any particular cooking chamber configuration or arrangement.

Oven appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

In general, cooking chamber 120 is defined by a plurality of chamber walls 130 (FIGS. 2 and 3). Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, oven appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

Referring now to FIG. 3, oven appliance 100 may include a plurality of racks 140 positioned within cooking chamber 120 for receiving food or cooking utensils containing food items. Racks 140 provide support for such food during a cooking process. According to the illustrated embodiment, racks 140 may be slidably mounted within cooking chamber 120 by one or more slide assemblies 142 that are mounted to a sidewall 130 of cooking chamber 120. Alternatively, racks 140 may be slidably received onto embossed ribs or sliding rails such that racks 140 may be conveniently moved into and out of cooking chamber 120.

As best shown in FIG. 3, oven appliance may include six rack supports 144 that are spaced apart along the vertical direction V. In addition, oven appliance 100 is illustrated as including three racks 140 that may each be slidably positioned on each of the six rack supports 144, such that six total rack positions are possible within cooking chamber 120. However, it should be appreciated that according to alternative embodiments, any suitable number of racks mounted in cooking chamber 120 in any suitable manner and being movable between any suitable number of positions is possible and within the scope of the present subject matter.

Oven appliance may further include one or more heating elements (identified generally by reference numeral 150) positioned within cabinet 102 or may otherwise be in thermal communication with cooking chamber 120 for regulating the temperature within cooking chamber 120. For example, heating elements 150 may be electric resistance heating elements, gas burners, microwave heating elements, halogen heating elements, or suitable combinations thereof. According to an exemplary embodiment, oven appliance 100 is a self-cleaning oven. In this regard, heating elements 150 may be configured for heating cooking chamber 120 to a very high temperature (e.g., 800° F. or higher) in order to burn off any food residue or otherwise clean cooking chamber 120.

Specifically, an upper gas or electric heating element 154 (also referred to as a broil heating element or gas burner) may be positioned in cabinet 102, e.g., at a top portion of cooking chamber 120, and a lower gas or electric heating element 156 (also referred to as a bake heating element or gas burner) may be positioned at a bottom portion of cooking chamber 120. Upper heating element 154 and lower heating element 156 may be used independently or simultaneously to heat cooking chamber 120, perform a baking or broil operation, perform a cleaning cycle, etc. The size and heat output of heating elements 154, 156 can be selected based on the, e.g., the size of oven appliance 100 or the desired heat output. Oven appliance 100 may include any other suitable number, type, and configuration of heating elements 150 within cabinet 102. For example, oven appliance 100 may further include electric heating elements, induction heating elements, or any other suitable heat generating device.

A user interface panel 160 is located within convenient reach of a user of the oven appliance 100. For this example embodiment, user interface panel 160 includes user inputs 162 that may generally be configured for regulating heating elements 150 or operation of oven appliance 100. In this manner, user inputs 162 allow the user to activate each heating element 150 and determine the amount of heat input provided by each heating element 150 to a cooking food items within cooking chamber 120. Although shown with user inputs 162, it should be understood that user inputs 162 and the configuration of oven appliance 100 shown in FIG. 1 is provided by way of example only. More specifically, user interface panel 160 may include various input components, such as one or more of a variety of touch-type controls, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element 150 is activated and/or the rate at which the heating element 150 is set.

Generally, oven appliance 100 may include a controller 166 in operative communication with user interface panel 160. User interface panel 160 of oven appliance 100 may be in communication with controller 166 via, for example, one or more signal lines or shared communication busses, and signals generated in controller 166 operate oven appliance 100 in response to user input via user inputs 162. Input/Output (“I/O”) signals may be routed between controller 166 and various operational components of oven appliance 100 such that operation of oven appliance 100 can be regulated by controller 166. In addition, controller 166 may also be communication with one or more sensors, such as temperature sensor 168 (FIG. 2), which may be used to measure temperature inside cooking chamber 120 and provide such measurements to the controller 166. Although temperature sensor 168 is illustrated at a top and rear of cooking chamber 120, it should be appreciated that other sensor types, positions, and configurations may be used according to alternative embodiments.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Referring still to FIG. 1, a schematic diagram of an external communication system 190 will be described according to an exemplary embodiment of the present subject matter. In general, external communication system 190 is configured for permitting interaction, data transfer, and other communications between and among oven appliance 100 and/or a user of oven appliance 100. For example, this communication may be used to provide and receive operating parameters, cycle settings, performance characteristics, user preferences, or any other suitable information for improved performance of oven appliance 100. In addition, external communication system 190 may be used to transfer images or video to a user of oven appliance 100.

External communication system 190 permits controller 166 of oven appliance 100 to communicate with external devices either directly or through a network 192. For example, a consumer may use a consumer device 194 to communicate directly with oven appliance 100. Alternatively, these appliances may include user interfaces for receiving such input (described below). For example, consumer devices 194 may be in direct or indirect communication with oven appliance 100, e.g., directly through a local area network (LAN), Wi-Fi, Bluetooth, Zigbee, etc. or indirectly through network 192. In general, consumer device 194 may be any suitable device for providing and/or receiving communications, displaying images or video, or receiving commands from a user. In this regard, consumer device 194 may include, for example, a personal phone, a tablet, a laptop computer, or another mobile device.

In addition, a remote server 196 may be in communication with oven appliance 100 and/or consumer device 194 through network 192. In this regard, for example, remote server 196 may be a cloud-based server 196, and is thus located at a distant location, such as in a separate state, country, etc. In general, communication between the remote server 196 and the client devices may be carried via a network interface using any type of wireless connection, using a variety of communication protocols (e.g. TCP/IP, HTTP, SMTP, FTP), encodings or formats (e.g. HTML, XML), and/or protection schemes (e.g. VPN, secure HTTP, SSL).

In general, network 192 can be any type of communication network. For example, network 192 can include one or more of a wireless network, a wired network, a personal area network, a local area network, a wide area network, the internet, a cellular network, etc. According to an exemplary embodiment, consumer device 194 may communicate with a remote server 196 over network 192, such as the internet, to provide user inputs, transfer operating parameters or performance characteristics, cycle authorizations, display images or video, etc. In addition, consumer device 194 and remote server 196 may communicate with oven appliance 100 to communicate similar information.

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more oven or cooking appliances, other communication protocols and steps may be implemented, etc. These variations and modifications are contemplated as within the scope of the present subject matter.

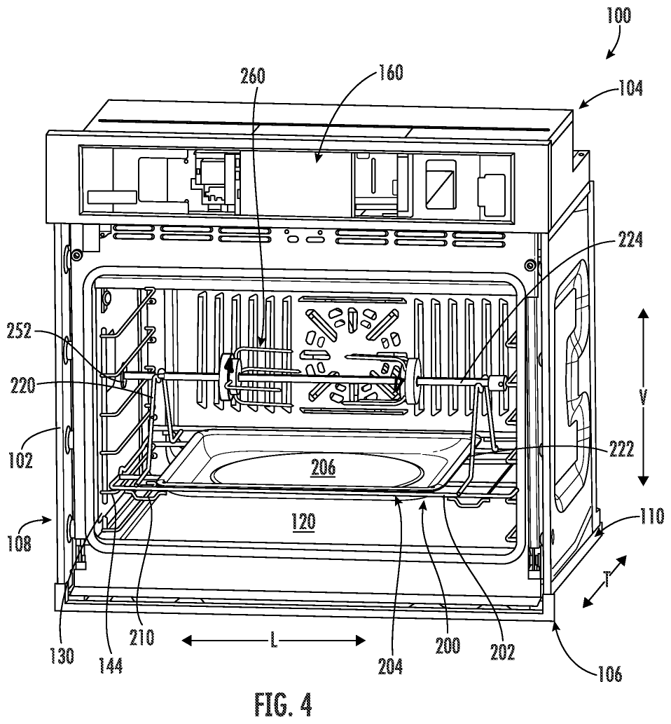

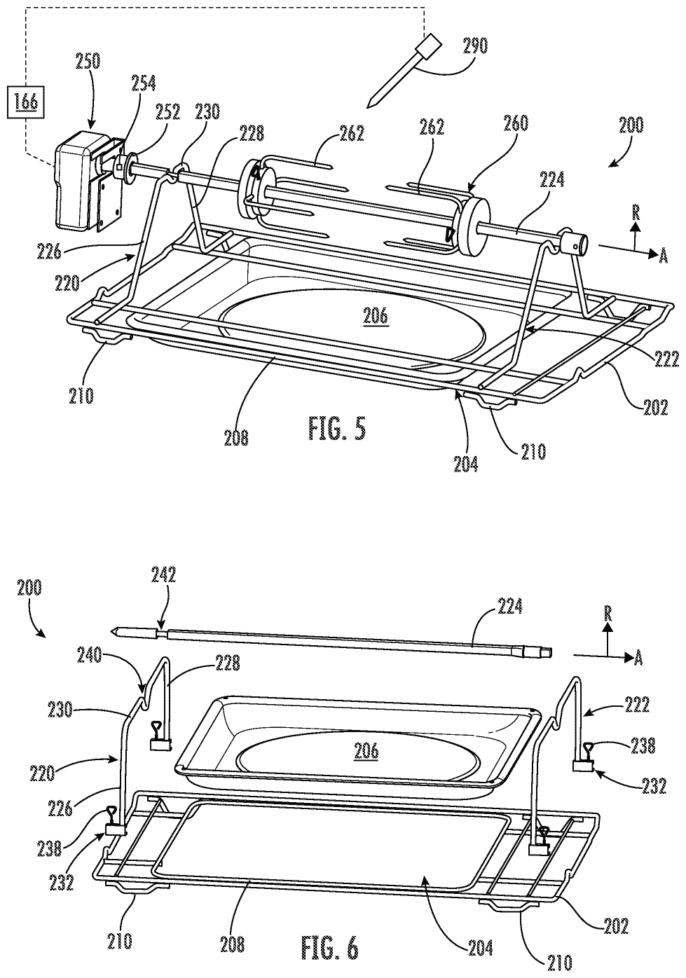

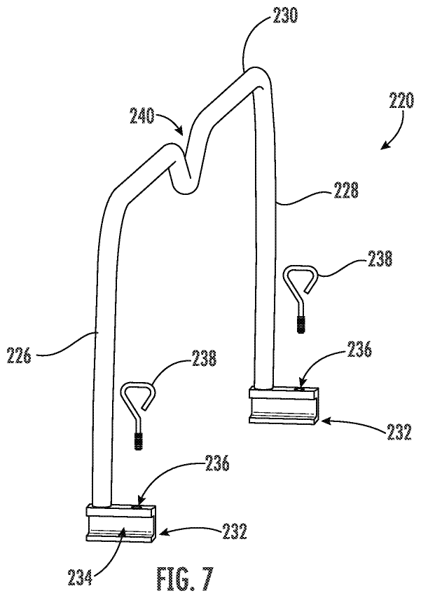

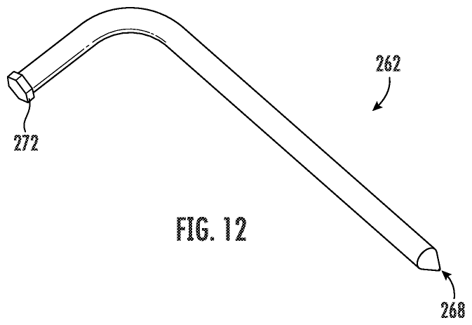

Referring now generally to FIGS. 4 through 12, a rotisserie assembly 200 that may be used with oven appliance 100 will be described according to an example embodiment of the present subject matter. Although rotisserie assembly 200 is described herein as being used with oven appliance 100, it should be appreciated that rotisserie assembly 200 may be used with other cooking appliances while remaining within the scope of the present subject matter. For example, rotisserie assembly 200 may be used with a range oven appliance, a double oven appliance, an oven appliance having a different configuration, or within any other suitable cooking cavity. The example embodiment described herein is not intended to limit the scope of the present subject matter in any manner.

As explained above, rotisserie cooking may commonly include the cooking of relatively large food items by mounting them on a spit and slowly rotating the spit within a heated cavity or over a heat source to roast the food item slowly and evenly. Although the rotisserie processes described herein are discussed with respect to large cuts of meat, such as turkeys, hams, or chickens, it should be appreciated that the cooking process described herein may be used for any suitable food item. In addition, the source of heat may vary while remaining within the scope of the present subject matter.

In general, rotisserie assembly 200 may include a rotisserie rack 202 that is slidably mounted within cooking chamber 120. In this regard, for example, sidewalls 130 of cooking chamber 120 may define a dedicated rack support 144 to facilitate the rotisserie cooking process. For example, this rack support 144 may include embossed ribs that are defined at a lower end of cooking chamber 120, e.g., below all other conventional rack supports 144. In addition, it should be appreciated that rotisserie rack 202 may be omitted altogether and rotisserie assembly 200 may be configured for directly mounting to other suitable features within cooking chamber 120, e.g., such as mounting brackets defined on a bottom chamber walls 130. Other variations and modifications are possible and within the scope of the present subject matter.

As best shown in FIGS. 4 through 6, rotisserie rack 202 may generally define a central aperture 204 that is positioned within the center of rotisserie rack 202. A drip tray 206 may be configured for seating within central aperture 204 where it may be supported by a perimeter wire 208. In this manner, drippings from the food items cooking during the rotisserie cooking process may fall into and collect within drip tray 206 for easy removal and cleaning. In addition, drip tray 206 may be configured for receipt of water or another suitable fluid that is heated and provides moisture into cooking chamber 120 throughout the rotisserie cooking process.

Rotisserie rack 202 may further define a plurality of standoff feet 210 that extend from a bottom of rotisserie rack 202. For example, rotisserie rack 202 is illustrated as defining four standoff feet 210 that are evenly spaced along a bottom of rotisserie rack 202 for providing firm footing or support for rotisserie rack 202. These standoff feet 210 may permit a user to set rotisserie rack 202 directly on a countertop while it is still warm after a rotisserie cooking process. According to an example embodiment, instead of rotisserie rack 202 being mounted on rack supports 144 of cooking chamber 120, rotisserie rack 202 can alternatively be mounted directly to bottom chamber wall 130 where it is supported by standoff feet 210.

Referring now generally to FIGS. 4 through 7, rotisserie assembly 200 may further include a first spit support 220 and a second spit support 222 that are mounted in cooking chamber 120 and are spaced apart along the lateral direction L. According to the illustrated embodiment, first spit support 220 and second spit support 222 are mounted directly to rotisserie rack 202 and extend along the vertical direction V for supporting a spit rod 224, as described in more detail below. However, it should be appreciated that according to alternative embodiments, first spit support 220 and second spit support 222 may be mounted directly to one or more chamber walls 130 of cooking chamber 120.

In general, each of first spit support 220 and second spit support 222 may include a front vertical arm 226 and a rear vertical arm 228 that are spaced apart along the transverse direction T. In addition, a cross arm 230 may extend along the transverse direction T between a distal end of front vertical arm 226 and rear vertical arm 228. In general, cross arm 230 may be configured for directly receiving spit rod 224 such that spit rod 224 is freely rotatable about an axial direction A (e.g., corresponding to the lateral direction L in the illustrated embodiment). It should be appreciated that the structure of first spit support 220 and second spit support 222 may vary to support spit rod 224 in other manners while remaining within the scope of the present subject matter.

According to the illustrated embodiment, rotisserie assembly 200 may further include a spit support bracket 232 that is attached to the bottom or proximal end of each of first spit support 220 and second spit support 222. More specifically, spit support brackets 232 may be positioned at the bottom of each front vertical arm 226 and a rear vertical arm 228 for directly engaging rotisserie rack 202. Specifically, as illustrated, spit support brackets 232 define a U-shaped receiving channel 234 that slides onto a wire of rotisserie rack 202 for providing vertical support. In addition, each spit support bracket 232 may define a threaded aperture 236 that passes through receiving channel 234. A screw 238 (e.g., such as a set screw) may be configured for receipt within threaded aperture 236 to secure spit support brackets 232 directly to rotisserie rack 202. It should be appreciated that other manners of attaching front vertical arm 226 and rear vertical arm 228 are possible and within the scope of the present subject matter.

As explained briefly above, spit rod 224 may generally be rotatably supported by first spit support 220 and second spit support 222. Spit rod 224 may generally define an axial direction A about which spit rod 224 is rotated during the rotisserie cooking process and a radial direction R that extends perpendicular to axial direction A. Notably, first spit support 220, second spit support 222, and spit rod 224 may generally define complementary features for ensuring smooth rotation of spit rod 224 and preventing spit rod 224 from translating along the axial direction A or falling off during the rotisserie cooking process. For example, first spit support 220 and second spit support 222 may generally define receiving slots 240 within which spit rod 224 may be securely seated. For example, receiving slots 240 may be V-shaped bends or indentations in each of first spit support 220 and second spit support 222. In addition, spit rod 224 may define two necked regions 242 where a diameter of spit rod 224 is reduced such that spit rod 224 engages first spit support 220 and second spit support 222 while preventing translation along the axial direction A.

Referring now to FIG. 5, rotisserie assembly 200 may further include a motor assembly 250 for engaging and selectively rotating spit rod 224 when spit rod 224 is in an installed position. In this regard, for example, motor assembly 250 may be positioned or mounted against chamber wall 130 on an outside of cooking chamber 120 and may be in operative communication with controller 166. Motor assembly 250 may include an engagement bushing 252 that is seated at least partially within cooking chamber 120 and that is configured for securely receiving spit rod 224 (e.g., through a keyed engagement structure). In this manner, motor assembly 250 may be thermally isolated from cooking chamber 120 but may rotate engagement bushing 252 and spit rod 224.

To install rotisserie assembly 200, a user may slide rotisserie rack 202 and spit rod 224 into cooking chamber 120 (e.g., along rack support 144). Notably, the rack support 144 associated with the rotisserie cooking process may be positioned at a predetermined height relative to engagement bushing 252 such that spit rod 224 is aligned along vertical direction V with engagement bushing 252 as rotisserie rack 202 is pushed into cooking chamber 120. A user may manually move spit rod 224 along the axial direction A slightly to align spit rod 224 and engagement bushing 252 before pressing spit rod 224 into engagement with engagement bushing 252. By contrast, to remove rotisserie assembly 200, a user may slide spit rod 224 away from engagement bushing 252 and may remove rotisserie rack 202.

Notably, it may be desirable to verify the proper installation of spit rod 224 within engagement bushing 252 prior to initiating a rotisserie cooking process. Accordingly, rotisserie assembly 200 may further include a microswitch 254 that is in operative communication with controller 166 for detecting when spit rod 224 is properly installed. For example, microswitch 254 may be a mechanical trigger, a button, a hall effect sensor, or any other device suitable for detecting the proper positioning of spit rod 224 and the engagement with motor assembly 250. If microswitch 254 determines that spit rod 224 is not properly installed, controller 166 may provide a user notification and request proper installation prior to initiating a rotisserie cooking process.

According to example embodiments of the present subject matter, rotisserie assembly 200 may further include a rotisserie fork assembly 260 that is mounted on spit rod 224 for securing one or more food items onto spit rod 224. In this regard, rotisserie fork assembly 260 may be configured to prevent rotation of the food items relative to spit rod 224, such that rotation of spit rod 224 causes corresponding rotation and cooking of the food items. Notably, as explained briefly above, conventional rotisserie forks are stationary or fixed structures that are sized for receiving food items of particular size. However, as food items cooking with rotisserie assembly 200 may vary, it is desirable to have a rotisserie fork assembly 260 that may be modified to properly support various food items. Although an exemplary rotisserie fork assembly 260 is described below, it should be appreciated that variations and modifications may be made while remaining within the scope of the present subject matter. Moreover, although a single rotisserie fork assembly 260 is described, it should be appreciated that rotisserie assembly 200 may include two or more rotisserie fork assemblies 260 (e.g., as shown for example in FIG. 4).

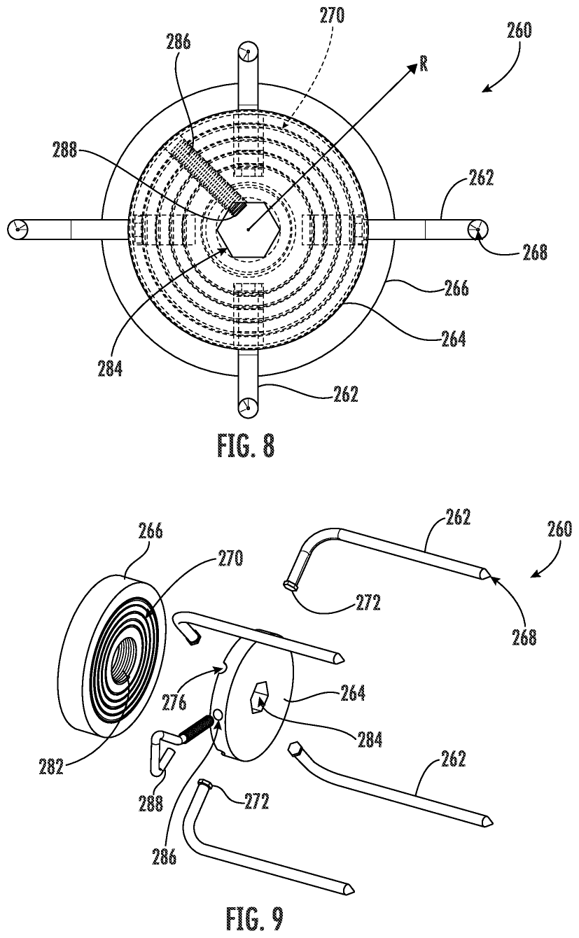

According to the illustrated embodiment, rotisserie fork assembly 260 may generally be mounted on spit rod 224 such that is slidable along the axial direction A. In addition, rotisserie fork assembly 260 may include a plurality of tines 262 that are adjustable along the radial direction R. More specifically, referring now also to FIGS. 8 through 12, rotisserie fork assembly 260 generally includes an inner disk 264 and an outer disk 266 that are joined to secure tines 262 in a desired radial position. Notably, tines 262 may all be fixed at the same radial position or at different radial positions depending on the uniformity of the food item being cooked. In addition, tines 262 may generally be L-shaped and define a pointed end 268 that is designed to pierce and secure food items.

According to the illustrated embodiment, inner disk 264 and outer disk 266 may generally define a plurality of annular grooves 270 where each of the annular grooves 270 define a different diameter measured along the radial direction R. In general, tines 262 extend between a proximal end that defines a mounting stud 272 and a distal end that defines pointed end 268. The geometry of inner disk 264, outer disk 266, and mounting studs 272 are designed to secure tines 262 in a fixed axial and radial position when properly installed.

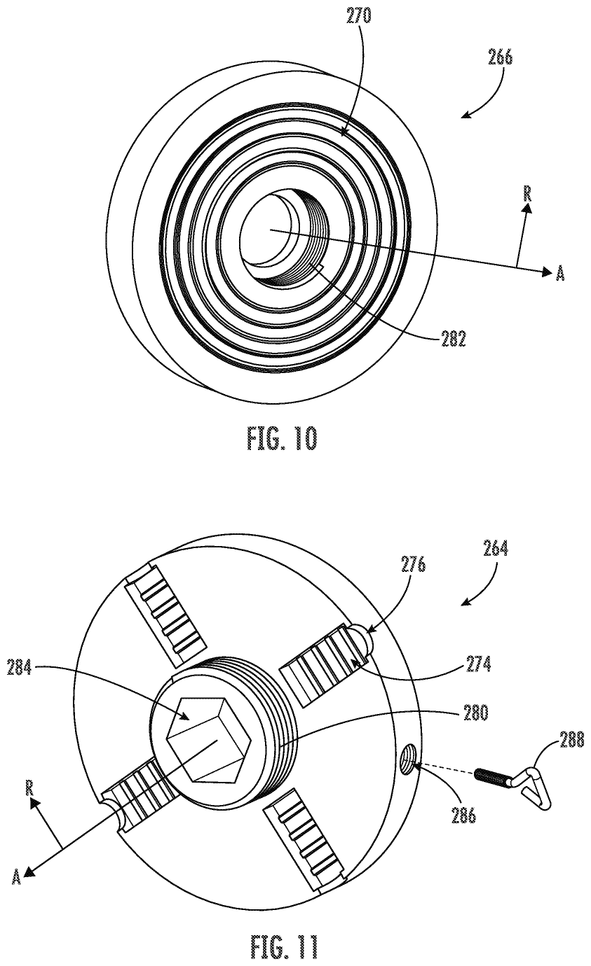

In this regard, for example, at least one of inner disk 264 and outer disk 266 may define a keyed surface 274 for engaging the mounting stud 272 and preventing its rotation about the radial direction R. For example, according to the illustrated embodiment, mounting stud 272 may be a hexagonal tip and the keyed surface 274 may be a flat face defined on the inner disk 264. Accordingly, when the inner disk 264 and outer disk 266 are secured together, tine 262 may not rotate relative to inner disk 264 and outer disk 266. As best shown in FIGS. 9 and 11, inner disk 264 may further define a plurality of radial notches 276 or recesses that are configured for receiving the plurality of tines 262, e.g., such that tines 262 may pass through a perimeter of inner disk 264 into annular grooves 270.

Referring now specifically to FIGS. 9 through 11, inner disk 264 and outer disk 266 may be configured for threaded engagement, e.g., whereby tines 272 are secured within annular grooves 270 and axial movement between inner disk 264 and outer disk 266 is prevented. In this regard, according to the illustrated embodiment, inner disk 264 may generally define male threads 280 and outer disk 266 may define female threads 282. Accordingly, when a user has position tines 272 against keyed surface 274 and in the desired radial position, outer disk 266 may be rotated on to inner disk 264 to secure all components of rotisserie fork assembly 260.

In addition, at least one of the inner disk 264 or outer disk 266 may define a keyed aperture 284 that is generally configured for receiving spit rod 224. For example, spit rod 224 may define a hexagonal cross-section that is configured for receipt through keyed aperture 284 to prevent relative rotation between spit rod 224 and rotisserie fork assembly 260. In addition, in order to secure the axial position of rotisserie fork assembly 260 on spit rod 224, at least one of the inner disk 264 and outer disk 266 may define a threaded radial aperture 286 that is generally configured for receiving a set screw 288. In this manner, a user may slide rotisserie fork assembly 260 along the axial direction A until the desired position is achieved and then may pass set screw 288 through threaded radial aperture 286 until it engages spit rod 224 to fix the axial position of rotisserie fork assembly 260.

Notably, it may be desirable to have temperature feedback during the rotisserie cooking process. Accordingly, rotisserie assembly 200 may further include a temperature sensor or a temperature probe 290 that is configured for being inserted into the food item for measuring an internal temperature of the food item. Controller 166 may be in operative communication with temperature probe 290 for receiving real time temperature feedback and regulating the operation of heating elements 150, motor assembly 250, and other aspects of the rotisserie cooking operation.

As used herein, “temperature sensor” or the equivalent is intended to refer to any suitable type of temperature measuring system or device positioned at any suitable location for measuring the desired temperature. Thus, for example, temperature probe 290 may each be any suitable type of temperature sensor, such as a thermistor, a thermocouple, a resistance temperature detector, a semiconductor-based integrated circuit temperature sensor, etc. In addition, temperature probe 190 may be positioned at any suitable location and may output a signal, such as a voltage, to a controller that is proportional to and/or indicative of the temperature being measured. Although exemplary positioning of temperature sensors is described herein, it should be appreciated that oven appliance 100 may include any other suitable number, type, and position of temperature, humidity, and/or other sensors according to alternative embodiments.

Now that the construction of oven appliance 100 and the configuration of controller 166 according to exemplary embodiments have been presented, an exemplary method 300 of operating an oven appliance including a rotisserie assembly will be described. Specifically, method 300 may be used to perform a rotisserie cooking process of an oven appliance, such as the oven appliance 100. Although the discussion below refers to the exemplary method 300 of operating oven appliance 100, one skilled in the art will appreciate that the exemplary method 300 is applicable to the operation of a variety of other oven appliances, such as oven range appliances. In exemplary embodiments, the various method steps as disclosed herein may be performed by controller 166 or a separate, dedicated controller.

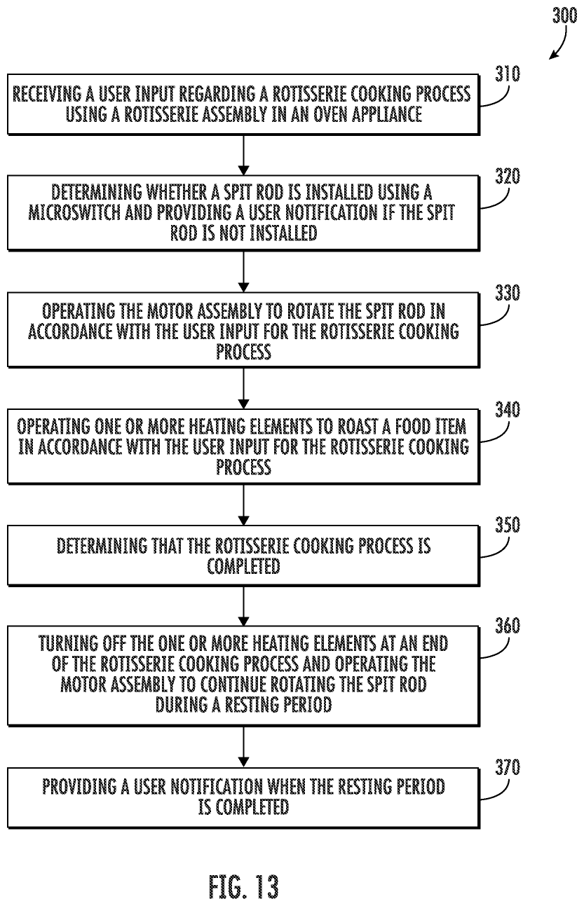

Specifically, referring now specifically to FIG. 13, method 300 includes, at step 310, receiving a user input regarding a rotisserie cooking process using a rotisserie assembly in an oven appliance. In this regard, for example, a user may manipulate user interface panel 160 (or may provide input via a remote device 194) to provide cooking information associated with the rotisserie cooking process. For example, the user input may include at least one of a food type, a food weight, a target doneness, a basting schedule, or any other information that may be used to facilitate an improved rotisserie cooking process. The user may then be instructed to install rotisserie assembly 200, e.g., by installing food items on spit rod 224 using rotisserie fork assembly 260, sliding in rotisserie rack 202, and engaging spit rod 224 with motor assembly 250.

Step 320 may generally include determining whether a spit rod is installed using a microswitch and providing a user notification if the spit rod is not installed. In this regard, step 320 may be used to verify the proper installation of rotisserie assembly 200 before initiating a rotisserie cooking process. Controller 166 may provide instructions to the user if spit rod 224 is not properly installed or other input or manipulations need to be made prior to initiating the rotisserie cooking process. If the microswitch is triggered, controller 166 may initiate the rotisserie cooking process.

Step 330 may generally include operating the motor assembly to rotate the spit rod in accordance with the user input for the rotisserie cooking process. In this regard, once all the desired input is received and the rotisserie assembly 200 is properly installed, controller 166 may operate motor assembly 250 to begin rotating spit rod 224 and food items positioned thereon. According to an example embodiment, the rotational speed may be varied throughout the rotisserie cooking process, e.g., based on the food type/weight, the chamber temperature, the internal temperature, and other factors.

Step 340 may include operating one or more heating elements to roast the food item in accordance with user input for the rotisserie cooking process. In this regard, controller 166 may regulate the heat output of one or more heating elements 150 throughout the rotisserie cooking process to achieve the desired cooking of the food item. The heating elements 150 and their heating output may be modulated throughout the cooking cycle, e.g., according to a predetermined heating schedule.

Step 350 may generally include determining that the rotisserie cooking process is completed. For example, the rotisserie cooking process may be a time-based process where cooking is complete at a predetermined time after cooking at a predetermined temperature. By contrast, step 350 may include determining that the internal temperature of the food item has reached a target temperature, e.g., using temperature probe 290.

Step 360 may generally include turning off the one or more heating elements at the end of the rotisserie cooking process and operating the motor assembly to continue rotating the spit rod during a resting period. In this regard, the resting period is intended to allow the juices to redistribute prior to removing the food item from rotisserie assembly 200. Step 370 may generally include providing a user notification when the resting period is complete (e.g., via a user interface panel 160 or remote device 194).

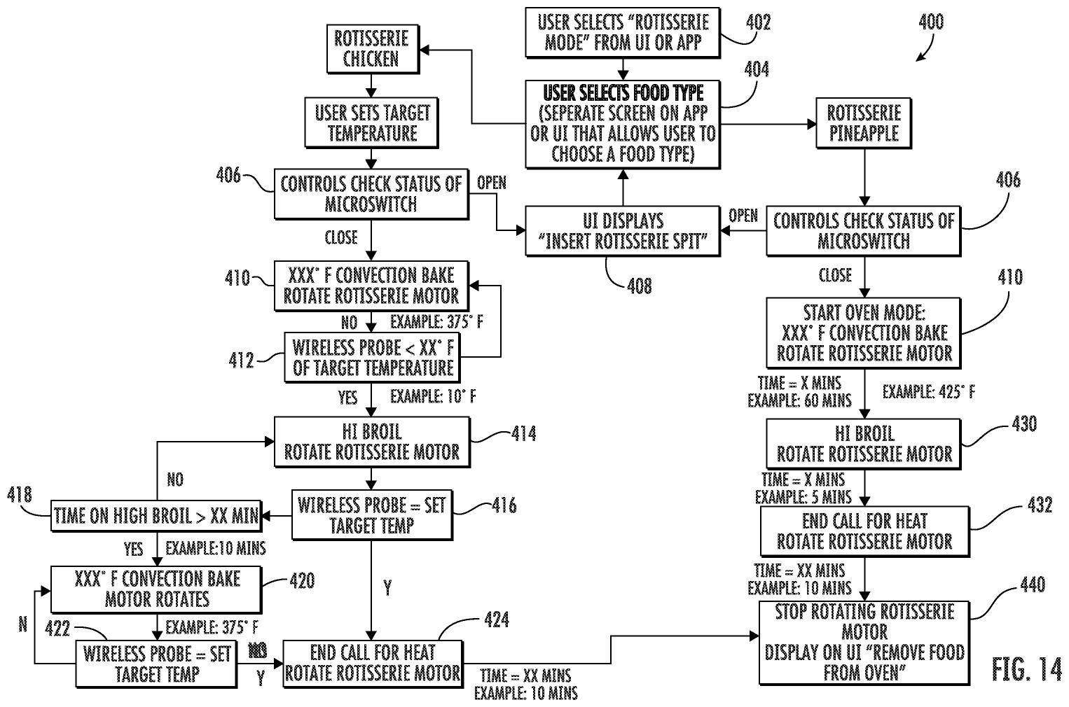

Referring now briefly to FIG. 14, an exemplary flow diagram of a rotisserie cooking process 400 that may be implemented by oven appliance 100 will be described according to an exemplary embodiment of the present subject matter. According to exemplary embodiments, method 400 may be similar to or interchangeable with method 300 and may be implemented by controller 166 of oven appliance 100. As shown, at step 402, a user may select the rotisserie mode through a user interface panel 160 or remote device 194. Step 404 may include obtaining user input, e.g., regarding food type and other cooking details. Step 406 may include checking status microswitch to determine whether rotisserie assembly 200 and spit rod 224 are properly installed. If the microswitch is open (indicating that spit rod 224 is not installed) a user notification may be provided at step 408.

Step 410 may generally include the initiation of the rotisserie cooking process, e.g., by starting one or more heating elements 150. Method 400 may then take different routes depending on whether the cooking process is time-based or temperature based. For example, for a temperature-based process, heat is maintained until the temperature measured by the temperature probe reaches a target temperature. After the target internal temperature is reached, step 414 may indicate a searing process where broil element is turned on for a brief period of time. Step 416 may include determining whether the internal temperature has reached another predetermined target temperature. If it has not, step 418 may include maintaining the broil element on until a predetermined amount of time has passed. After the predetermined amount of time has passed, step 420 may include performing another convection bake cycle at a predetermined temperature level until another predetermined target temperature is reached at step 422. Step 424 may include shutting off heating elements 150 and the rotating of motor assembly 250 for a predetermined resting period.

Referring now to a time-based process (e.g., illustrated on the right in FIG. 14), a timer may be initiated at step 410 at the initiation of a convection bake process. Step 430 illustrates the commencement of a broiling or searing process after the convection bake process has completed (e.g., 60 minutes at 425° F.). Step 432 includes the shutting off heating elements 150 and the continued rotation of spit rod 224 for a resting period. Step 440 includes stopping rotation of spit rod 224 and providing a user notification (e.g., via a user interface panel 160 or remote device 194) that the food items are ready for removal from cooking chamber 120. Other steps are possible and within the scope of the present subject matter.

FIGS. 13 and 14 depict steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 300 and method 400 are explained using oven appliance 100 as an example, it should be appreciated that this method may be applied to the operation of any suitable oven appliance and rotisserie assembly.

As explained herein, aspects of the present subject matter are generally directed to an adjustable rotisserie fork assembly. The assembly may include an inner and outer disk. The outer disk may be embossed in multiple radial positions in which the prongs head can be placed. The inner disk may have slots with ridges to hold prongs in various positions. Furthermore, the inner and outer disks may be screwed together to hold the prongs in place. Each prong of the rotisserie fork may include a head on the end to nest inside the chosen groove of the disk so it can be locked into place. The assembly can be slid into place on the spit, and then the set screw gets tightened onto the spit to hold the assembly in place.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance defining a vertical, a lateral, and a transverse direction, the oven appliance comprising:
a cooking chamber positioned within a cabinet;
a door rotatably mounted to the cabinet for providing selective access to the cooking chamber; and
a rotisserie assembly comprising:
a spit rod rotatably mounted within the cooking chamber and defining an axial direction and a radial direction; and
a rotisserie fork assembly mounted on the spit rod and being slidable along the axial direction, the rotisserie fork assembly comprising a plurality of tines that are adjustable along the radial direction.

2. The oven appliance of claim 1, wherein the rotisserie fork assembly comprises:
an inner disk and an outer disk that define a plurality of annular grooves, each of the annular grooves defining a different diameter measured along the radial direction.

3. The oven appliance of claim 2, wherein a proximal end of each of the plurality of tines defines a mounting stud and at least one of the inner disk and the outer disk defines a keyed surface for engaging the mounting stud and preventing rotation of the plurality of tines relative to the inner disk and the outer disk.

4. The oven appliance of claim 3, wherein the mounting stud is a hexagonal tip and the keyed surface is a flat face defined by the inner disk or the outer disk.

5. The oven appliance of claim 2, wherein the inner disk defines a plurality of radial notches for receiving the plurality of tines.

6. The oven appliance of claim 1, wherein the plurality of tines are L-shaped.

7. The oven appliance of claim 2, wherein the inner disk and the outer disk may be configured for threaded engagement.

8. The oven appliance of claim 7, wherein the inner disk defines male threads and outer disk defines female threads for threaded engagement.

9. The oven appliance of claim 2, wherein at least one of the inner disk or the outer disk define a keyed aperture for receiving the spit rod.

10. The oven appliance of claim 2, wherein a threaded radial aperture is defined in at least one of the inner disk and the outer disk, the rotisserie assembly further comprising:
a set screw configured for receipt within the threaded radial aperture to secure the rotisserie fork assembly to the spit rod.

11. The oven appliance of claim 1, wherein fork assembly is a first fork assembly and the rotisserie assembly further comprises:
a second fork assembly identical to the first fork assembly.

12. The oven appliance of claim 1, further comprising:
a rotisserie rack slidably mounted within the cooking chamber; and
a first spit support and a second spit support mounted to the rotisserie rack, wherein the spit rod is rotatably mounted to the first spit support and the second spit support.

13. A rotisserie assembly for an oven appliance, the oven appliance comprising a cooking chamber positioned within a cabinet, the rotisserie assembly comprising:
a spit rod rotatably mounted within the cooking chamber and defining an axial direction and a radial direction; and
a rotisserie fork assembly mounted on the spit rod and being slidable along the axial direction, the rotisserie fork assembly comprising a plurality of tines that are adjustable along the radial direction.

14. The rotisserie assembly of claim 13, wherein the rotisserie fork assembly comprises:
an inner disk and an outer disk that define a plurality of annular grooves, each of the annular grooves defining a different diameter measured along the radial direction.

15. The rotisserie assembly of claim 14, wherein a proximal end of each of the plurality of tines defines a mounting stud and at least one of the inner disk and the outer disk defines a keyed surface for engaging the mounting stud and preventing rotation of the plurality of tines relative to the inner disk and the outer disk.

16. The rotisserie assembly of claim 14, wherein the inner disk defines a plurality of radial notches for receiving the plurality of tines.

17. The rotisserie assembly of claim 14, wherein the inner disk defines male threads and outer disk defines female threads for threaded engagement.

18. The rotisserie assembly of claim 14, wherein at least one of the inner disk or the outer disk define a keyed aperture for receiving the spit rod.

19. The rotisserie assembly of claim 14, wherein a threaded radial aperture is defined in at least one of the inner disk and the outer disk, the rotisserie assembly further comprising:
a set screw configured for receipt within the threaded radial aperture to secure the rotisserie fork assembly to the spit rod.

20. The rotisserie assembly of claim 13, wherein fork assembly is a first fork assembly and the rotisserie assembly further comprises:
a second fork assembly identical to the first fork assembly.
